(19) United States
(12) Patent Application Publication
(10) Pub. No.: US 2016/0123186 A1
(43) Pub. Date: May 5, 2016

(54) SHROUD ASSEMBLY FOR A TURBINE ENGINE

(71) Applicant: General Electric Company, Schenectady, NY (US)

(72) Inventors: Curtis Walton STOVER, Mason, OH (US); Michael Alan MEADE, Liberty Township, OH (US)

(21) Appl. No.: 14/860,801

(22) Filed: Sep. 22, 2015

Related U.S. Application Data
(60) Provisional application No. 62/073,555, filed on Oct. 31, 2014.

(51) Int. Cl. F01D 25/14; F01D 25/28

(52) U.S. Cl. CPC F01D 25/14; F01D 25/28; F05D 2220/323; F05D 2260/202; F05D 2260/2212

(57) ABSTRACT

A shroud assembly for a turbine engine includes a shroud in thermal communication with a hot combustion gas flow and a baffle overlying the shroud to define a space. At least one separator is provided in the space such that a cooling fluid flow passing through the baffle is separated along two different flow paths.

Turbine engines, and particularly gas or combustion turbine engines, are rotary engines that extract energy from a flow of combusted gases passing through the engine onto a multitude of turbine blades. Gas turbine engines have been used for land and nautical locomotion and power generation, but are most commonly used for aeronautical applications such as for aircraft, including helicopters. In aircraft, gas turbine engines are used for propulsion of the aircraft. In terrestrial applications, turbine engines are often used for power generation.

Gas turbine engines for aircraft are designed to operate at high temperatures to maximize engine efficiency, so cooling of certain engine components, such as the high pressure turbine and the low pressure turbine, may be necessary. Typically, cooling is accomplished by ducting cooler air from the high and/or low pressure compressors to the engine components which require cooling. Temperatures in the high pressure turbine are around 1000° C. to 2000° C. and the cooling air from the compressor is about 500° C. to 700° C. While the compressor air is a high temperature, it is cooler relative to the turbine air, and may be used to cool the turbine.

Turbine shrouds have been cooled using different methods, including conventional convection cooling and impingement cooling. In conventional convection cooling, cooling air flows along a single cooling path through the shroud, and heat is transferred by convection into the flowing air. In impingement cooling, the inner surface of the shroud is impinged with high velocity air in order to transfer more heat by convection than with typical convection cooling.

Particles, such as dirt, dust, sand, and other environmental contaminants, in the cooling air can cause a loss of cooling and reduced operational time or “time-on-wing” for the aircraft environment. For example, particles supplied to the turbine components can clog, obstruct, or coat the flow passages and surfaces of the components, which can reduce the lifespan of the components. This problem is exacerbated in certain operating environments around the globe where turbine engines are exposed to significant amounts of airborne particles.

### BRIEF DESCRIPTION OF THE INVENTION

In one aspect, the invention relates to a shroud assembly for a turbine section of a turbine engine, comprising a shroud having a hot surface in thermal communication with a hot combustion gas flow and a cooling surface, with the cooling surface being different than the hot surface, a baffle overlying the shroud and having a first surface in fluid communication with a cooling fluid flow and a second surface, different from the first surface, spaced from the cooling surface and defining a space between the second surface and the cooling surface, at least one cooling aperture extending through the baffle from the first surface to the second surface and defining a cooling fluid flow path defining a cooling fluid streamline, and at least one separator provided in the space between the second surface and the cooling surface and located relative to the cooling fluid flow path such that the cooling fluid flow exiting the at least one cooling aperture is separated into at least a first cooling flow having a first flow path and a second cooling flow having a second flow path in a different direction than the first flow path. Both the first and second flow paths contact the cooling surface of the shroud.

In another aspect, the invention relates to a shroud assembly for a turbine section of a turbine engine, comprising a shroud having a hot surface in thermal communication with a hot combustion gas flow and a cooling surface, with the cooling surface being different than the hot surface, a baffle overlying the shroud and having a first surface in fluid communication with a cooling fluid flow and a second surface, different from the first surface, spaced from the cooling surface and defining a space between the second surface and the cooling surface, multiple cooling apertures extending through the baffle from the first surface to the second surface, and at least one separator provided in the space between the second surface and the cooling surface and located relative to the cooling apertures such that the cooling fluid flow exiting the cooling apertures is separated into at least a first cooling flow having a first flow path and a second cooling flow having a second flow path in a different direction than the first flow path. Both the first and second flow paths contact the cooling surface of the shroud.

### BRIEF DESCRIPTION OF THE DRAWINGS

In the drawings:

FIG. 1 is a schematic cross-sectional diagram of a gas turbine engine for an aircraft.

FIG. 2 is a schematic sectional view showing a shroud assembly of the engine from FIG. 1 according to a first embodiment of the invention.

FIG. 3 is a close-up view of FIG. 2.

FIG. 4 is a perspective sectional view of a shroud assembly according to a second embodiment of the invention.

FIG. 5 is a schematic sectional view showing a shroud assembly according to a third embodiment of the invention.

FIG. 6 is a schematic sectional view showing a shroud assembly according to a fourth embodiment of the invention.

FIG. 7 is an overhead view of a cooling feature for a shroud assembly in the form of turbulators.

FIG. 8 is a profile view of the turbulators of FIG. 7.

FIG. 9 is an overhead view of a cooling feature for a shroud assembly in the form of pin fins.

FIG. 10 is a profile view of the pin fins of FIG. 9.

FIG. 11 is an overhead view of a cooling feature for a shroud assembly in the form of aerodynamic fins.

FIG. 12 is a profile view of the aerodynamic fins of FIG. 11.

### DESCRIPTION OF EMBODIMENTS OF THE INVENTION

The described embodiments of the present invention are directed to cooling an engine component, particularly in a turbine engine. For purposes of illustration, the present invention will be described with respect to an aircraft gas turbine engine. It will be understood, however, that the invention is not so limited and may have general applicability in non-aircraft applications, such as other mobile applications and non-mobile industrial, commercial, and residential applications. It is further noted that while the various embodiments of systems, methods, and other devices related to the invention are discussed and shown herein in the context of a shroud assembly for a turbine section of a turbine engine, the invention may be applied to other sections of a turbine engine. Some non-limiting examples may include, but are not limited to, turbine vanes, turbine blades, turbine nozzles, combustor liners, turbine disks, and turbine seals. Further, the invention may have non-engine applications as well.

As used herein, the terms “axial” or “axially” refer to a dimension along a longitudinal axis of an engine. The term “forward” used in conjunction with “axial” or “axially” refers to moving in a direction toward the engine inlet, or a component being relatively closer to the engine inlet as compared to another component. The term “aft” used in conjunction with “axial” or “axially” refers to a direction toward the rear or outlet of the engine relative to the engine centerline.

As used herein, the terms “radial” or “radially” refer to a dimension extending between a center longitudinal axis of the engine and an outer engine circumference. The use of the terms “proximal” or “proximally,” either by themselves or in conjunction with the terms “radial” or “radially,” refers to moving in a direction toward the center longitudinal axis, or a component being relatively closer to the center longitudinal axis as compared to another component. The use of the terms “distal” or “distally,” either by themselves or in conjunction with the terms “radial” or “radially,” refers to moving in a direction toward the outer engine circumference, or a component being relatively closer to the outer engine circumference as compared to another component.

All directional references (e.g., radial, axial, proximal, distal, upper, lower, upward, downward, left, right, lateral, front, back, top, bottom, above, below, vertical, horizontal, clockwise, counterclockwise) are only used for identification purposes to aid the reader's understanding of the present invention, and do not create limitations, particularly as to the position, orientation, or use of the invention. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. The exemplary drawings are for purposes of illustration only and the dimensions, positions, order and relative sizes reflected in the drawings attached hereto may vary.

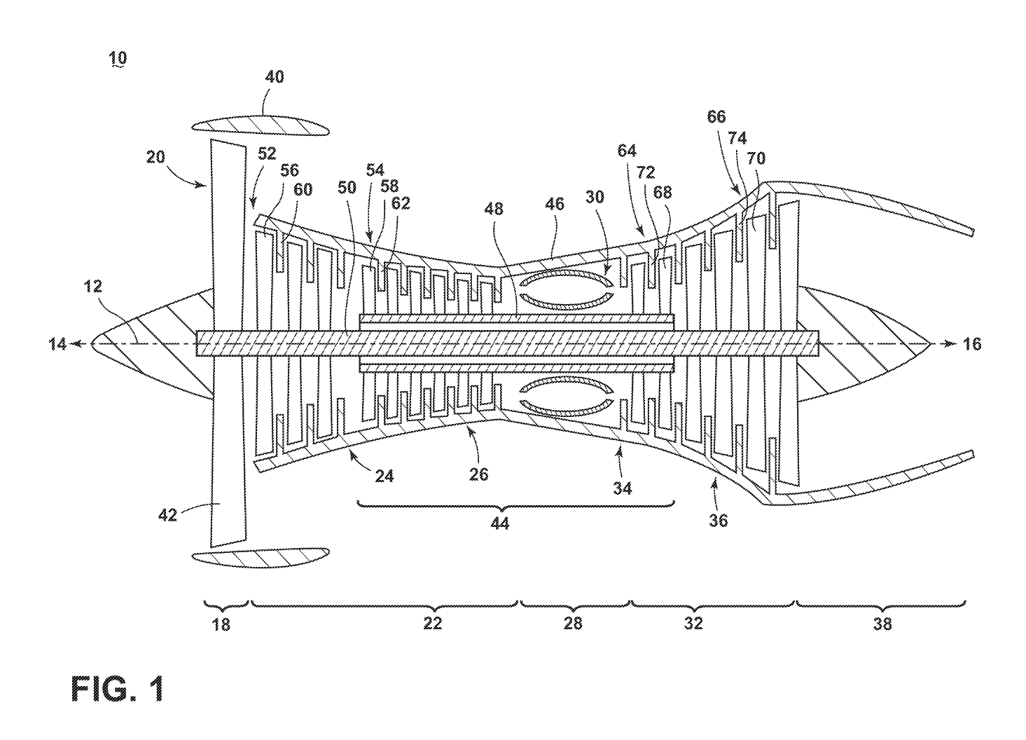

FIG. 1 is a schematic cross-sectional diagram of a gas turbine engine 10 for an aircraft. The engine 10 has a generally longitudinally extending axis or centerline 12 extending forward 14 to aft 16. The engine 10 includes, in downstream serial flow relationship, a fan section 18 including a fan 20, a compressor section 22 including a booster or low pressure (LP) compressor 24 and a high pressure (HP) compressor 26, a combustion section 28 including a combustor 30, a turbine section 32 including a HP turbine 34, and a LP turbine 36, and an exhaust section 38.

The fan section 18 includes a fan casing 40 surrounding the fan 20. The fan 20 includes a plurality of fan blades 42 disposed radially about the centerline 12.

The HP compressor 26, the combustor 30, and the HP turbine 34 form a core 44 of the engine 10 which generates combustion gases. The core 44 is surrounded by core casing 46 which can be coupled with the fan casing 40.

A HP shaft or spool 48 disposed coaxially about the centerline 12 of the engine 10 drivingly connects the HP turbine 34 to the HP compressor 26. A LP shaft or spool 50, which is disposed coaxially about the centerline 12 of the engine 10 within the larger diameter annular HP spool 48, drivingly connects the LP turbine 36 to the LP compressor 24 and fan 20.

The LP compressor 24 and the HP compressor 26 respectively include a plurality of compressor stages 52, 54, in which a set of compressor blades 56, 58 rotate relative to a corresponding set of static compressor vanes 60, 62 (also called a nozzle) to compress or pressurize the stream of fluid passing through the stage. In a single compressor stage 52, 54, multiple compressor blades 56, 58 may be provided in a ring and may extend radially outwardly relative to the centerline 12, from a blade platform to a blade tip, while the corresponding static compressor vanes 60, 62 are positioned downstream of and adjacent to the rotating blades 56, 58. It is noted that the number of blades, vanes, and compressor stages shown in FIG. 1 were selected for illustrative purposes only, and that other numbers are possible.

The HP turbine 34 and the LP turbine 36 respectively include a plurality of turbine stages 64, 66, in which a set of turbine blades 68, 70 are rotated relative to a corresponding set of static turbine vanes 72, 74 (also called a nozzle) to extract energy from the stream of fluid passing through the stage. In a single turbine stage 64, 66, multiple turbine blades 68, 70 may be provided in a ring and may extend radially outwardly relative to the centerline 12, from a blade platform to a blade tip, while the corresponding static turbine vanes 72, 74 are positioned upstream of and adjacent to the rotating blades 68, 70. It is noted that the number of blades, vanes, and turbine stages shown in FIG. 1 were selected for illustrative purposes only, and that other numbers are possible.

In operation, the rotating fan 20 supplies ambient air to the LP compressor 24, which then supplies pressurized ambient air to the HP compressor 26, which further pressurizes the ambient air. The pressurized air from the HP compressor 26 is mixed with fuel in combustor 30 and ignited, thereby generating combustion gases. Some work is extracted from these gases by the HP turbine 34, which drives the HP compressor 26. The combustion gases are discharged into the LP turbine 36, which extracts additional work to drive the LP compressor 24, and the exhaust gas is ultimately discharged from the engine 10 via the exhaust section 38. The driving of the LP turbine 36 drives the LP spool 50 to rotate the fan 20 and the LP compressor 24.

Some of the ambient air supplied by the fan 20 may bypass the engine core 44 and be used for cooling of portions, especially hot portions, of the engine 10, and/or used to cool or power other aspects of the aircraft. Other sources of cooling fluid may be, but is not limited to, fluid discharged from the LP compressor 24 or the HP compressor 26.

In the context of a turbine engine, the hot portions of the engine are normally downstream of the combustor 30, especially the turbine section 32, with the HP turbine 34 being the hottest portion as it is directly downstream of the combustion section 28. In one example, the hot portion may be a shroud or shroud assembly located adjacent to the rotating blades of the turbine or compressor.

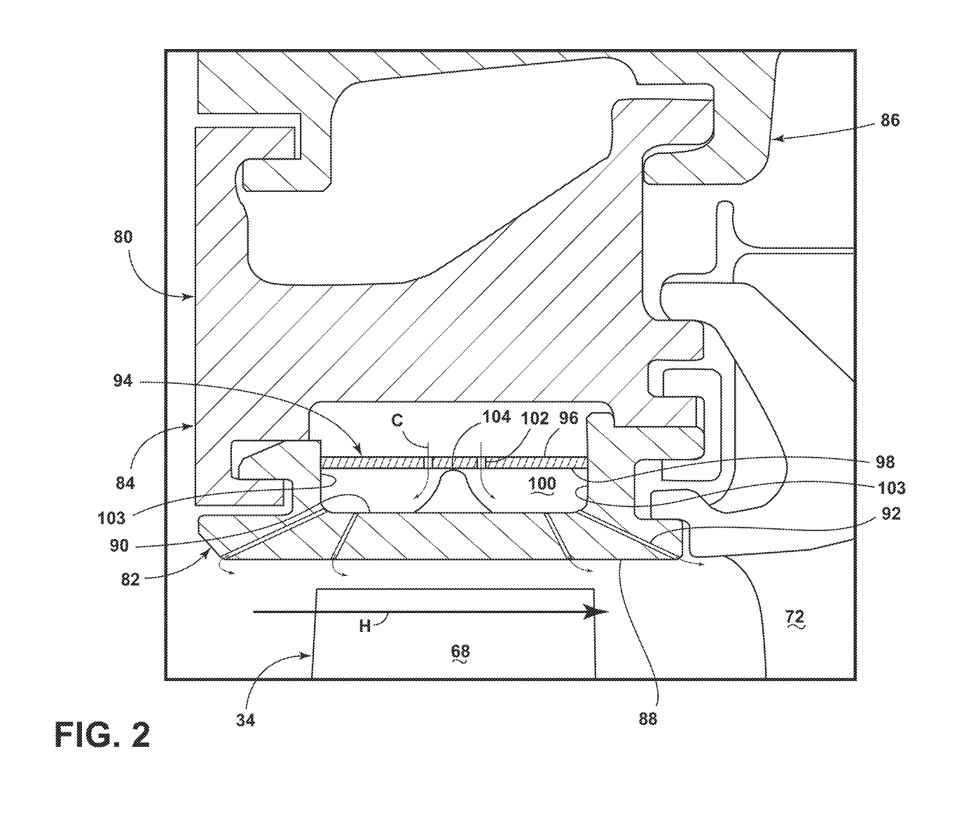

FIG. 2 is a schematic view showing a shroud assembly 80 of the engine 10 from FIG. 1 according to first embodiment of the invention, which may be cooled by the cooling fluid. The shroud assembly is shown as being associated with a blade 68 of the HP turbine 34, although the shroud assembly can alternatively be associated with the LP turbine 36, the LP compressor 24, or the HP compressor 26.

The shroud assembly 80 includes a shroud 82 spaced radially about the blades 68 and a hanger 84 configured to couple the shroud 82 with a casing of the engine 10 and retain the shroud in position, adjacent to the blade 68. The hanger 84 can directly mount the shroud 82 to the core casing 46 of the engine (see FIG. 1), or can indirectly couple the shroud 82 with the core casing 46 via a hanger support 86, as shown herein. The shroud 82 and hanger 84 extend circumferentially, and the engine 10 from FIG. 1 may include multiple shroud assemblies 80 extending around the circumference defined by the blades 68.

The shroud 82 has a hot surface 88 in thermal communication with a hot combustion gas flow H, such as heated gas emitted from the combustor 30, and a cooling surface 90. Here, the hot surface 88 confronts one of the blades 68 of the HP turbine 34 and the cooling surface 90 is opposite the hot surface 88. The shroud 82 can further comprise one or more film holes 92 that extend through at least a portion of the shroud 82 between the hot and cooling surfaces 88, 90. As illustrated, multiple film holes 92 are provided and extend radially to fluidly couple the space 100 to an exterior of the shroud 82. The cooling fluid may pass out of the space via the film holes 92 to form a cooling film over some or all of the hot surface 88 of the shroud 82. The film holes 92 are typically forward or aft of the blades 68 because the fluid motion at the tip of the rotating blades 68 interferes with the fluid leaving the film holes 92 at the hot surface 88. While not shown, a protective coating, such as a thermal barrier coating, or multi-layer coating system can be applied to the hot surface 88 of the shroud 82.

The shroud assembly 80 further includes a baffle 94 which overlies at least a portion of the shroud 82 and directs a cooling fluid flow C toward the cooling surface 90 of the shroud 82. The baffle 94 has a first surface 96 in fluid communication with the cooling fluid flow C and a second surface 98 that is spaced from the cooling surface 90 and defines a space 100 between the baffle 94 and shroud 82. The baffle 94 includes one or more cooling aperture(s) 102 through which the cooling fluid flow C passes and is directed toward the cooling surface 90 of the shroud 82.

As shown, the baffle 94 comprises a wall located within an interior of the shroud 82, with the wall defining the first and second surfaces 96, 98. The space 100 between the second surface 98 of the baffle 94 and the cooling surface 90 is formed from at least a portion of the interior of the shroud 82, including the radially-extending wall 103 of the shroud 82 which engage the hanger 84.

The shroud assembly 80 further includes at least one separator 104 provided in the space 100 between the baffle 94 and shroud 82 for directing the flow of cooling air in the space 100. The separator 104 can be oriented within the engine 10 (FIG. 1) such that the first flow path is directed forward relative to the engine centerline 12 and the second flow path is directed aft relative to the engine centerline 12.

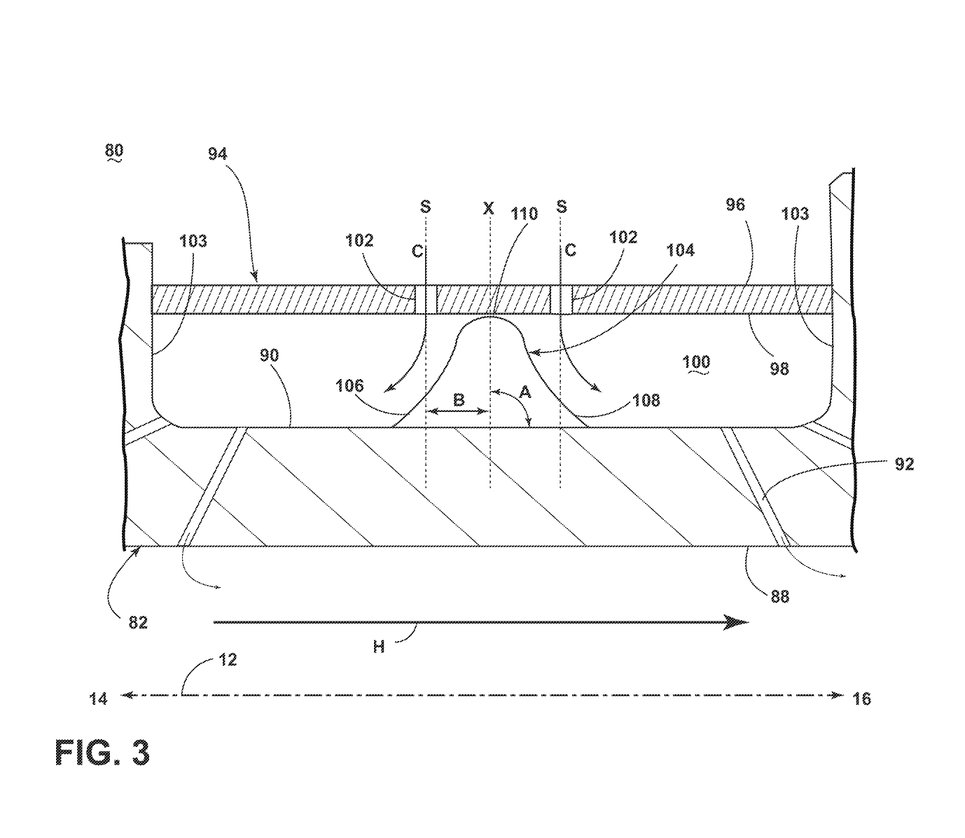

FIG. 3 is a close-up view of FIG. 2 showing the shroud 82 and baffle 94. The cooling surface 90 of the shroud 82 is generally opposite the hot surface 88, and the first surface 96 of the baffle 94 is generally opposite the second surface 96. As shown, the first and second surfaces 96, 98 of the baffle 94 are parallel to each other, however, variations in the relative angle between the first and second surfaces 96, 98 of the baffle 94 can be incorporated.

The cooling apertures 102 open into the space 100 between the baffle 94 and shroud 82, and can comprise impingement holes, or orifices, through which the cooling fluid flow C is directed through the baffle 94. Each cooling aperture 102 defines a cooling fluid flow path, which defines a cooling fluid streamline. The cooling apertures 102 may be normal, angled, or non-orthogonal relative to the surfaces 96, 98 of the baffle 94 and the cooling surface 90 of the shroud 82. In this embodiment, an array of apertures 102 are normal relative to the baffle 94 and the cooling surface 90 of the shroud 82.

It is noted that the cooling apertures 102 may be of various sizes and shapes, and may further be uniformly spaced or may be non-uniformly spaced apart. The cooling apertures 102 may also be of one uniform cross-sectional shape or of varying cross-sectional shapes, and further may be of uniform size, varying size, or formed in a range of sizes.

The separator 104 includes a forward wall 106 and an aft wall 108 that extend radially from the cooling surface 90 of the shroud 82 and terminating in a tip 110. The walls 106, 108 may be curvilinear, arcuate or linear. The tip 110 of the separator may be arcuate, flat, or pointed. In this embodiment, the streamlines defined by the cooling apertures 102 are offset from the tip 110, such that cooling fluid is directed down either wall 106, 108 of the separator 104. The separator 104 may extend circumferentially with the shroud 82 along the entire span of the shroud 82, or may extend a sub-length of the shroud 82. In other configurations, the separator 104 may extend at least partially or fully axially with the shroud 82.

The tip 110 may contact the second surface 98 of the baffle 94 to divide the space 100 into a forward space and an aft space. Cooling fluid flow C entering into the forward space can be directed forwardly in the shroud 82 while cooling fluid flow C entering into the aft space can be directed aft. Alternatively, the tip 110 may be spaced from the baffle 94, with the separator 104 still effectively dividing the space 100 by its radial extension from the cooling surface 90.

The separator 104 further has a body axis X which forms a separator angle A relative to the cooling surface 90 of the shroud 82. The separator angle A is preferably greater than 0 degrees and less than 180 degrees; in the illustrated embodiment, the separator angle A is 90 degrees. Streamlines S of cooling fluid defined by the apertures 102 as the cooling fluid C exits the baffle 94, form a streamline angle B relative to the body axis X, and the streamline angle B can be between 0 and 90 degrees. In this embodiment, the streamline angle B is 0 degrees, as the streamlines S are generally parallel to the body axis X.

In operation, cooling fluid flow C is supplied to the shroud assembly 80 to cool the shroud 82, which is exposed to hot combustion gas H. In order to cool the shroud, the cooling fluid is at a temperature that is less than the operational temperature of the shroud 82; i.e. the temperature of the shroud 82 during normal operation of the engine 10. The cooling fluid flow C passes through the cooling apertures 102 of the baffle 94, and into the space 100 defined with the shroud 82. The cooling path through the shroud 82 is bifurcated, such that the incoming cooling air flow C is divided by the separator 104, and directed to the fore and aft regions of the shroud 82. The cooling air flow C may then pass through the film holes 92 to form a cooling film over some or all of the hot surface 88 of the shroud 82.

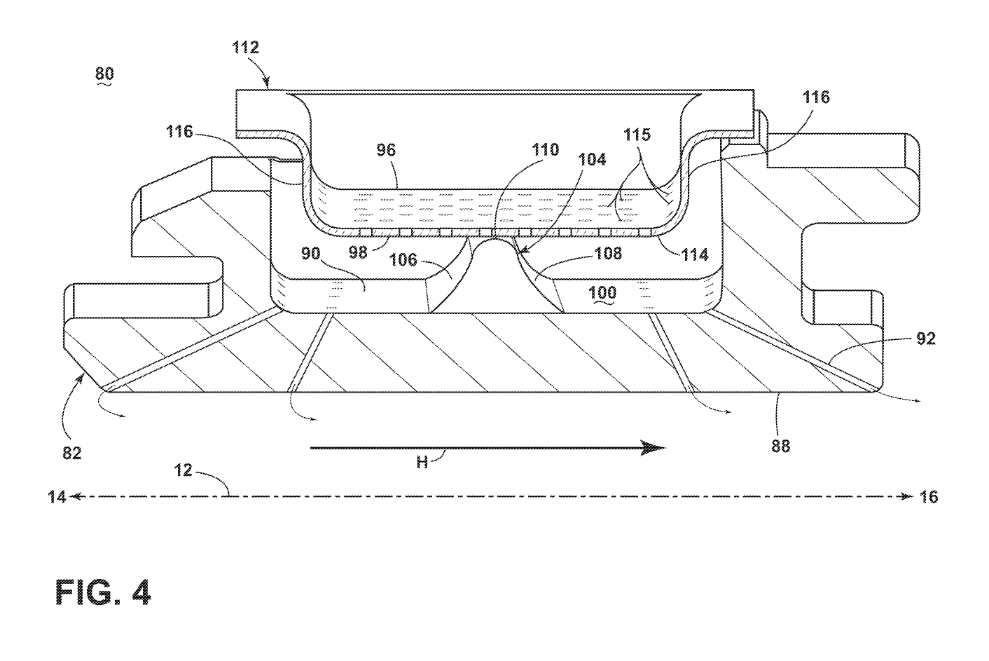

FIG. 4 is a perspective sectional view of a shroud assembly 80 according to a second embodiment of the invention. The second embodiment is substantially similar to the first embodiment, and like elements will be identified with the same reference numerals. The second embodiment differs from the first in that the shroud assembly 80 has a baffle in the form of an insert 112 located within the interior of the shroud 82. The insert 112 can be generally U-shaped in cross-section, and includes a wall 114 defining the first and second surfaces 96, 98, and two sides 116 curving radially outwardly from the wall 114. An array of cooling apertures 117 extend through the both the wall 114 and the sides 116 of the insert 112. At least some of the cooling apertures 117 may run along the tip 110, while other apertures 117 are fore or aft of the tip 110.

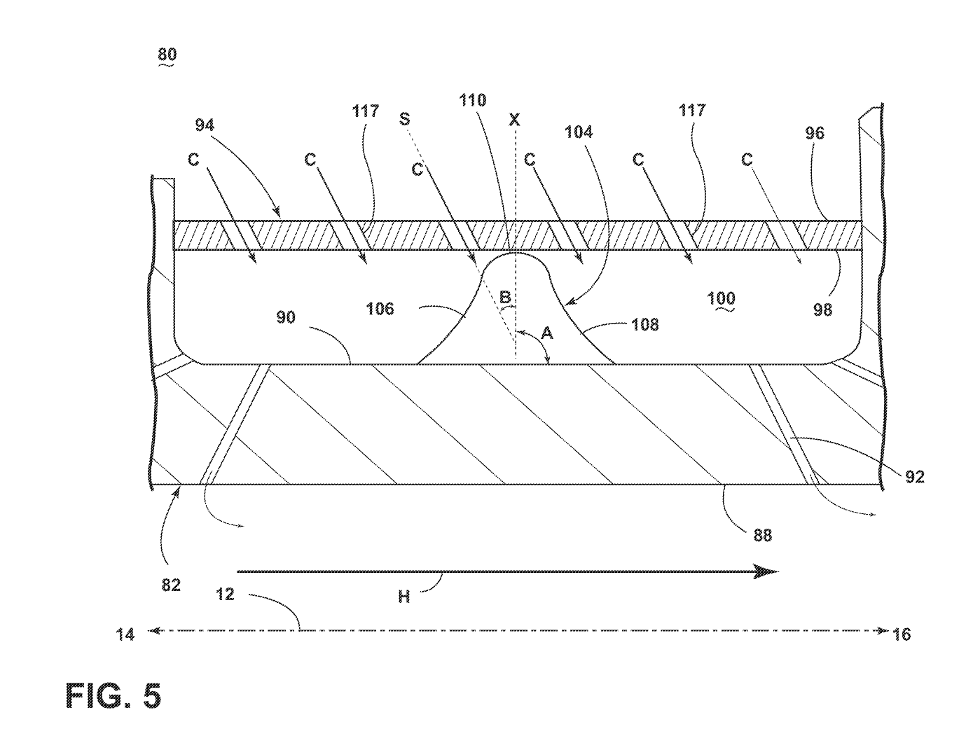

FIG. 5 is a schematic sectional view showing a shroud assembly 80 according to a third embodiment of the invention. The third embodiment is substantially similar to the first embodiment, and like elements will be identified with the same reference numerals. The third embodiment differs from the first in that the baffle 94 is provided with angled cooling apertures 117, such that the cooling fluid flow C impinges upon the cooling surface 90 of the shroud 82 at an angle. The streamlines of cooling fluid defined by the apertures 117 extend at an acute angle between the first and second surfaces 96, 98 of the baffle 94 and are non-orthogonal relative to the tip 110 of the separator. In the illustrated embodiment, all cooling apertures 117 are shown as being angled in the aft direction 16. Alternatively, at least some cooling apertures 117 can be angled in the forward direction 14.

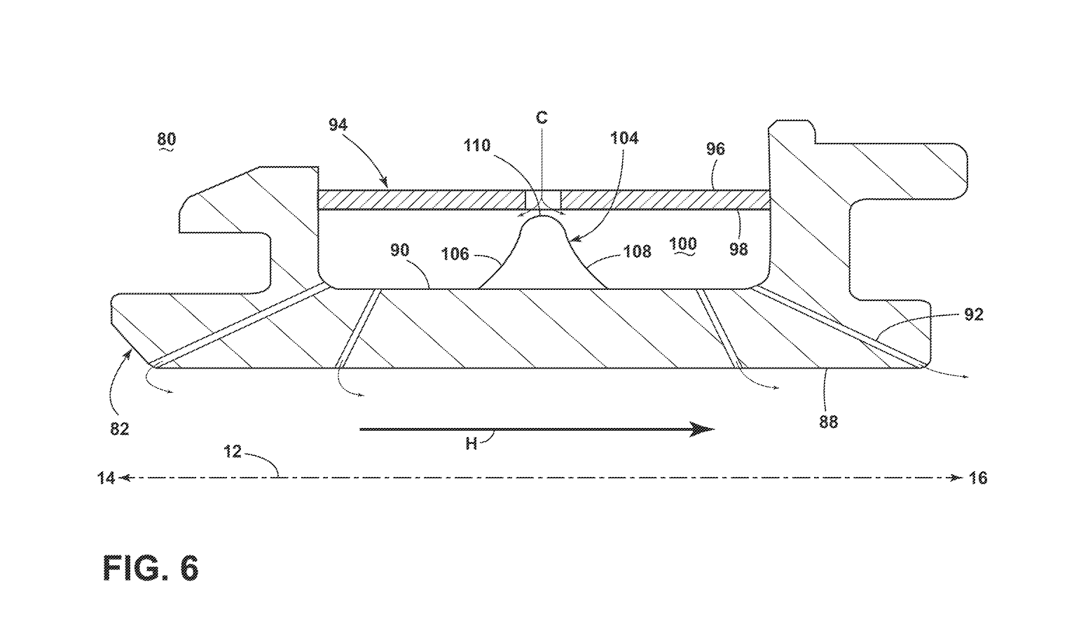

FIG. 6 is a schematic sectional view showing a shroud assembly according to a fourth embodiment of the invention. The fourth embodiment is substantially similar to the first embodiment, and like elements will be identified with the same reference numerals. In the fourth embodiment, the cooling apertures 102, only one of which is visible in FIG. 6, can be aligned with the separator 104 such that the streamlines of cooling fluid defined by the apertures 102 are collinear with the body axis X and meets the tip 110.

In any of the above embodiments, it is understood that the drawings may not be to scale, particularly with respect to the relative sizes of the separator 104, cooling apertures 100, and the space 100 between the baffle 94 and cooling surface 90, and that the size of certain components may be exaggerated for clarity in the drawings. Furthermore, while the separator 104 is illustrated as having a generally convexly-curved tip 110 and concavely-curved side walls 106, 108, other shapes for the separator 104 are possible.

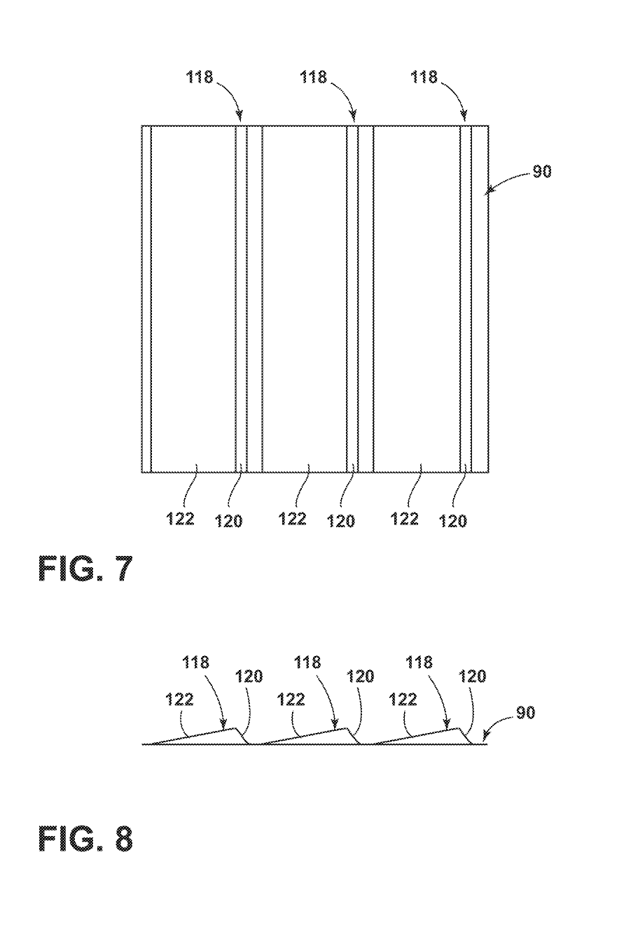

FIGS. 7-12 show some examples of discrete cooling features which can be provided on the cooling surface 90 of the shroud 82. The discrete cooling features can generally extend from the cooling surface 90 of the shroud 82 to increase the surface area of the cooling surface 90 for heat transfer as well as increase the turbulence in the cooling fluid flow to avoid stagnation points. The cooling features can be provided forward and/or aft of the separator 104, and can be oriented with respect to the flow direction of the cooling fluid flow passing over the cooling surface 90 of the shroud 82.

FIGS. 7-8 show one example in which the cooling feature comprises a plurality of turbulators 118. The turbulators 118 each comprise a leading edge wall 120 and a trailing edge wall 122 that extend from the cooling surface 90 of the shroud. The trailing edge wall 122 can taper from the leading edge wall 120 in the direction of air flow, and is longer than the leading edge wall 120. The leading and trailing edge walls 120, 122 may be curvilinear, arcuate or linear. Suitable turbulators are more fully described in U.S. Pat. No. 8,408,872, issued Apr. 2, 2013, which is incorporated herein by reference in its entirety. Other suitable turbulators may have a squared-off cross-section with a generally planar top wall joining leading and trailing edge walls, rather than the ramped cross-section shown herein.

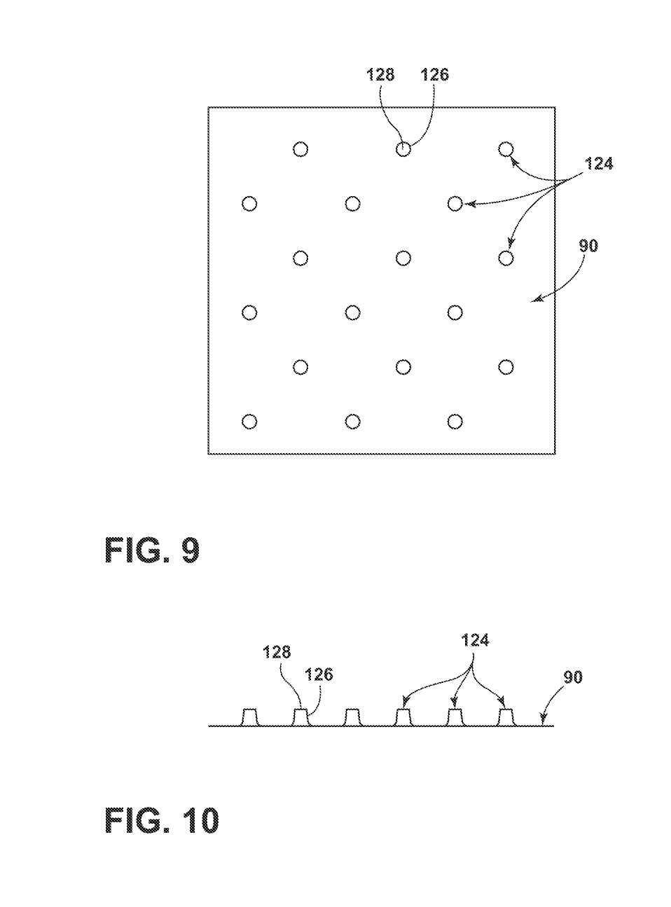

FIGS. 9-10 show one example in which the cooling feature comprises a plurality of pin fins 124. The pin fins 124 each comprise a peripheral surface 126 that extends from the cooling surface 90 of the shroud 82 in a radial direction to an upper surface 128. The peripheral surface 126 may be curvilinear, arcuate or linear, and the upper surface 128 may be circular.

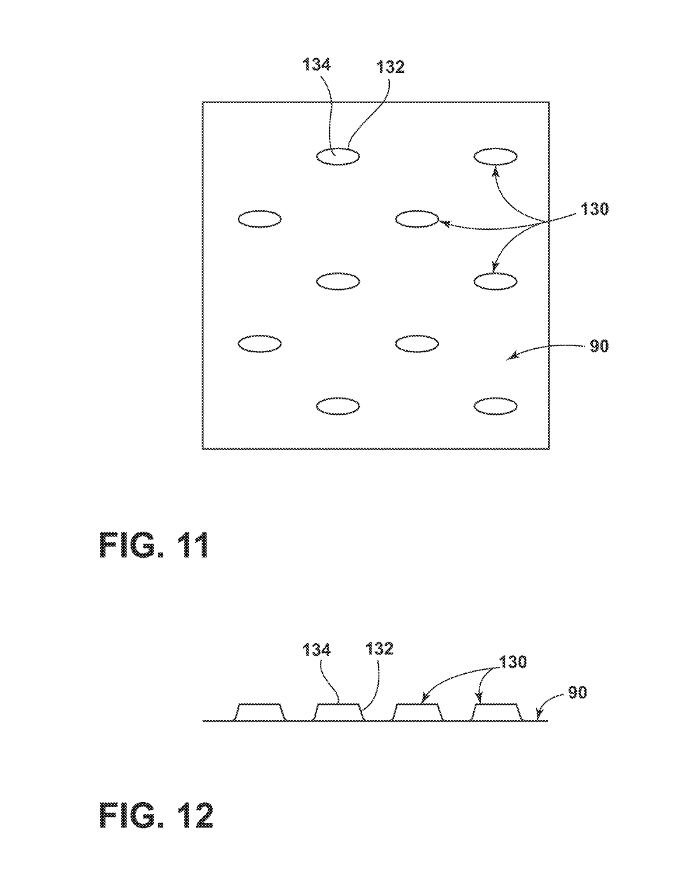

FIGS. 10-11 show one example in which the cooling feature comprises a plurality of aerodynamic fins 130. The aerodynamic fins 130 each comprise a peripheral surface 132 that extends from the cooling surface 90 of the shroud 82 in a radial direction to an upper surface 134. The peripheral surface 132 may be curvilinear, arcuate or linear, and the upper surface 134 may be ovoid.

The various embodiments of systems, methods, and other devices related to the invention disclosed herein provide improved cooling for engine structures, particularly in a shroud for a turbine engine. One advantage that may be realized in the practice of some embodiments of the described systems is that the convective cooling of the shroud of the present invention removes the issue of particle accumulation associated with impingement cooling. Another advantage that may be realized in the practice of some embodiments of the described systems and methods is that the bifurcated cooling path, in which the incoming cooling air is divided and directed to the fore and aft regions of the shroud, improves cooling by minimizing the distance the air must flow.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A shroud assembly for a turbine section of a turbine engine, comprising:
a shroud having a hot surface in thermal communication with a hot combustion gas flow and a cooling surface, with the cooling surface being different than the hot surface;
a baffle overlying the shroud and having a first surface in fluid communication with a cooling fluid flow and a second surface, different from the first surface, spaced from the cooling surface and defining a space between the second surface and the cooling surface;
at least one cooling aperture extending through the baffle from the first surface to the second surface and defining a cooling fluid flow path defining a cooling fluid streamline; and
at least one separator provided in the space between the second surface and the cooling surface and located relative to the cooling fluid flow path such that the cooling fluid flow exiting the at least one cooling aperture is separated into at least a first cooling flow having a first flow path and a second cooling flow having a second flow path in a different direction than the first flow path;
wherein both the first and second flow paths contact the cooling surface of the shroud.

2. The shroud assembly of claim 1 wherein the baffle comprises a wall located within an interior of the shroud.

3. The shroud assembly of claim 2 wherein the space between the second surface and the cooling surface is formed from at least a portion of the interior of the shroud.

4. The shroud assembly of claim 2 wherein the wall comprises an insert located within the interior of the shroud and the at least one cooling apertures extends through the insert.

5. The shroud assembly of claim 1 wherein the at least one separator has a body axis which forms a separator angle relative to the cooling surface of the shroud, and the separator angle is greater than 0 degrees and less than 180 degrees.

6. The shroud assembly of claim 5 wherein the cooling fluid streamline forms a streamline angle relative to the body axis, and the streamline angle is between 0 and 90 degrees.

7. The shroud assembly of claim 1 wherein the at least one separator extends upwardly from the cooling surface of the shroud and terminates in a tip.

8. The shroud assembly of claim 7 wherein the cooling fluid streamline is aligned with the tip.

9. The shroud assembly of claim 8 wherein the cooling fluid streamline is non-orthogonal relative to the tip.

10. The shroud assembly of claim 9 wherein the cooling fluid streamline extends at an acute angle between the first and second surfaces of the baffle.

11. The shroud assembly of claim 10 wherein the tip is spaced below the second surface of the baffle.

12. The shroud assembly of claim 11 wherein the second surface is parallel to the first surface.

13. The shroud assembly of claim 1 wherein the at least one separator is oriented within an engine such that the first flow path is directed forward relative to the engine and the second flow path is directed aft relative to the engine.

14. The shroud assembly of claim 1 wherein the cooling surface of the shroud is generally opposite the hot surface, and the first surface of the baffle is generally opposite the second surface.

15. The shroud assembly of claim 1 further comprising at least one cooling feature spaced from the at least one separator and located within at least one of the first flow path or the second flow path.

16. The shroud assembly of claim 15 wherein the cooling feature comprises at least one of a turbulator, pin fin, or aerodynamic fin.

17. The shroud assembly of claim 1 further comprising multiple cooling apertures for the at least one separator.

18. The shroud assembly of claim 1 further comprising multiple separators with a corresponding cooling aperture.

19. The shroud assembly of claim 18 further comprising multiple cooling apertures for at least some of the multiple separators.

20. A shroud assembly for a turbine section of a turbine engine, comprising:
a shroud having a hot surface in thermal communication with a hot combustion gas flow and a cooling surface, with the cooling surface being different than the hot surface;
a baffle overlying the shroud and having a first surface in fluid communication with a cooling fluid flow and a second surface, different from the first surface, spaced from the cooling surface and defining a space between the second surface and the cooling surface;
multiple cooling apertures extending through the baffle from the first surface to the second surface; and
at least one separator provided in the space between the second surface and the cooling surface and located relative to the cooling apertures such that the cooling fluid flow exiting the cooling apertures is separated into at least a first cooling flow having a first flow path and a second cooling flow having a second flow path in a different direction than the first flow path;
wherein both the first and second flow paths contact the cooling surface of the shroud.

21. The shroud assembly of claim 20 wherein the baffle comprises a wall located within an interior of the shroud.

22. The shroud assembly of claim 21 wherein the space between the second surface and the cooling surface is formed from at least a portion of the interior of the shroud.

23. The shroud assembly of claim 21 wherein the wall comprises an insert located within the interior of the shroud and the at least one cooling apertures extends through the insert.

24. The shroud assembly of claim 20 wherein the at least one separator has a body axis which forms a separator angle relative to the cooling surface of the shroud, and the separator angle is greater than 0 degrees and less than 180 degrees.

25. The shroud assembly of claim 24 wherein each of the multiple cooling apertures define a streamline of the cooling fluid which forms a streamline angle relative to the body axis, and the streamline angle is between 0 and 90 degrees.

26. The shroud assembly of claim 20 wherein the at least one separator extends upwardly from the cooling surface of the shroud and terminates in a tip.

27. The shroud assembly of claim 26 wherein the multiple cooling apertures are misaligned with the tip.

28. The shroud assembly of claim 27 wherein each of the multiple cooling apertures define a streamline of that cooling fluid that is non-orthogonal relative to the tip.

29. The shroud assembly of claim 28 wherein the streamlines extend at acute angles between the first and second surfaces of the baffle.

30. The shroud assembly of claim 29 wherein the tip is spaced below the second surface of the baffle.

31. The shroud assembly of claim 30 wherein the second surface is parallel to the first surface.

32. The shroud assembly of claim 20 wherein the at least one separator is oriented within an engine such that the first flow path is directed forward relative to the engine and the second flow path is directed aft relative to the engine.

33. The shroud assembly of claim 20 wherein the cooling surface of the shroud is generally opposite the hot surface, and the first surface of the baffle is generally opposite the second surface.

34. The shroud assembly of claim 20 further comprising at least one cooling feature spaced from the at least one separator and located within at least one of the first flow path or the second flow path.

35. The shroud assembly of claim 34 wherein the cooling feature comprises at least one of a turbulator, pin fin, or aerodynamic fin.
